(19) United States
(12) Patent Application Publication
(10) Pub. No.: US 2008/0109825 A1
(43) Pub. Date: May 8, 2008

(54) METHOD FOR AUTOMATICALLY NOTIFYING OF SCHEDULE BY PORTABLE TERMINAL

(76) Inventor: Nan Sook Kim, Daegu Metropolitan City (KR)

Correspondence Address: CHA & REITER, LLC, 210 ROUTE 4 EAST STE 103, PARAMUS, NJ, 07652, US

(21) Appl. No.: 11/752,469

(22) Filed: May 23, 2007

(30) Foreign Application Priority Data
Nov. 2, 2006 (KR) 2006-0107545

(51) Int. Cl. G06F 9/46

(52) U.S. Cl. 719/318; 718/102

(57) ABSTRACT

A method for automatically notifying of a schedule by a portable terminal includes the steps of detecting an integrated schedule notification event, extracting normal schedules corresponding to a period of time, and displaying all extracted normal schedules corresponding to the period of time as the integrated schedule at the starting point of the period of time. The user can check the entire schedule corresponding to a period of time (e.g. week, month) so that a user can manage the schedule in a more convenient and stable manner.

### CLAIM OF PRIORITY

This application claims the benefit of the earlier filing date, pursuant to 35 USC 119, to that patent application entitled “METHOD FOR AUTOMATICALLY NOTIFYING OF SCHEDULE BY PORTABLE TERMINAL” filed in the Korean Intellectual Property Office on Nov. 2, 2006 and assigned Serial No. 2006-0107545, the contents of which are incorporated herein by reference.

### BACKGROUND OF THE INVENTION

1. Field of the Invention

The present invention relates generally to a method for automatically notifying of a schedule by a portable terminal and, more particularly, to a method for automatically notifying of a schedule by a portable terminal, wherein schedules corresponding to a specific period of time are extracted from registered schedules and are displayed as an integrated schedule.

2. Description of the Related Art

Modern people frequently make a business or personal appointment and try to keep it. However, they may forget the appointment or be late for it when occupied with the complexities of daily life. Therefore, people use a diary to write down their schedule or input the schedule into a portable terminal, which can manage the schedule conveniently. For example, a user can manage his/her schedule by inputting the date and time at which he/she wants to be notified of the schedule, as well as the particulars of the schedule into his/her portable terminal so that it notifies of the schedule at the desired date and time and displays the particulars.

However, conventional schedule management methods have a problem in that users have difficulty in managing their overall schedule, because they are only notified of registered appointments one after another at the corresponding date and time. In addition, when users want to modify the schedule, they must inconveniently go through various menus of the portable terminal until they find the schedule management menu.

### SUMMARY OF THE INVENTION

The present invention has been made in view of the above problems, and discloses a method for automatically notifying of a schedule by a portable terminal, wherein the user is informed of the entire schedule corresponding to a specific period of time at the desired notification time.

Another method for automatically notifying of a schedule by a portable terminal, is disclosed wherein, when the user wants to modify the particulars of the schedule corresponding to a specific period of time, he/she can easily select and modify the schedule on the notification screen.

In accordance with an exemplary embodiment of the present invention, there is provided a method for automatically notifying of a schedule by a portable terminal, the method including the steps of detecting an integrated schedule notification event, extracting normal schedules corresponding to a period of time selected for an integrated schedule and displaying all extracted normal schedules as the integrated schedule.

In accordance with another exemplary embodiment of the present invention, there is provided a method for automatically notifying of a schedule by a portable terminal, the method including the steps of selecting an integrated schedule notification event, detecting a schedule notification event of the portable terminal, determining if the detected schedule notification event corresponds to the selected integrated schedule notification event and displaying an integrated schedule when the integrated schedule notification event is detected.

In accordance with another exemplary embodiment of the present invention, there is provided a method for automatically notifying of a schedule by a portable terminal, the method including the steps of selecting an integrated schedule notification event, detecting a schedule notification event of the portable terminal, determining if the detected schedule notification event corresponds to the selected integrated schedule notification event and displaying all registered normal schedules corresponding to a period of time as an integrated schedule when the integrated schedule notification event is detected.

### BRIEF DESCRIPTION OF THE DRAWINGS

The above features and advantages of the present invention will be more apparent from the following detailed description in conjunction with the accompanying drawings, in which:

FIG. 1 is a block diagram showing major components of a portable terminal adapted to automatically notify of a schedule according to an embodiment of the present invention;

FIG. 2 is a flowchart showing a method for determining particulars necessary to automatically notify of a schedule according to an embodiment of the present invention;

FIG. 3 is a flowchart showing a method for displaying a schedule according to an embodiment of the present invention;

FIG. 4 is a flowchart showing a detailed method for managing a schedule according to an embodiment of the present invention;

FIG. 5 is a flowchart showing a method for transmitting a text message so as to notify of a schedule according to an embodiment of the present invention;

FIG. 6A shows an exemplary screen displaying an integrated schedule for a week according to an embodiment of the present invention; and

FIG. 6B shows an exemplary screen displaying an integrated schedule for a month according to an embodiment of the present invention.

### DETAILED DESCRIPTION OF THE INVENTION

Hereinafter, exemplary embodiments of the present invention are described in detail with reference to the accompanying drawings. The same reference symbols identify the same or corresponding elements in the drawings. For the purposes of clarity and simplicity, detailed descriptions of constructions or processes known in the art may be omitted to avoid obscuring the invention in unnecessary detail.

An embodiment of the present invention will now be described with regard to a portable terminal. It can be easily understood by those skilled in the art that the portable terminal, which is used to provide its user with various types of convenience, may be any type of communication device or multimedia device, such as a mobile communication terminal capable of schedule management, a mobile telephone, a PDA (Personal Digital Assistant), a smart phone, a laptop computer, and a conventional computer.

As used herein, “normal schedule” refers to a schedule in the conventional sense, which is stored in the portable terminal with regard to the desired notification date and time, as well as particulars of the schedule. In addition, “integrated schedule” refers to a list of integrated normal schedules corresponding to a predetermined period of time. For example, if a week is determined as the desired period, the integrated schedule refers to a list of all normal schedules corresponding to the week, which have been stored in the portable terminal.

According to an embodiment of the present invention, the integrated schedule is displayed on the screen at a predetermined time. The screen returns to the condition before displaying the integrated schedule after some time has elapsed. If the user wants the integrated schedule to be displayed again after the time period has elapsed, or if he/she wants to modify the integrated schedule or add a new schedule to it, he/she can use the menu of the portable terminal or operate a key so as to enter into the integrated schedule mode.

The predetermined period of time is used as a basis for integrating normal schedules and displaying them. The period can be selected by the user as desired, and may be a week, a month, etc.

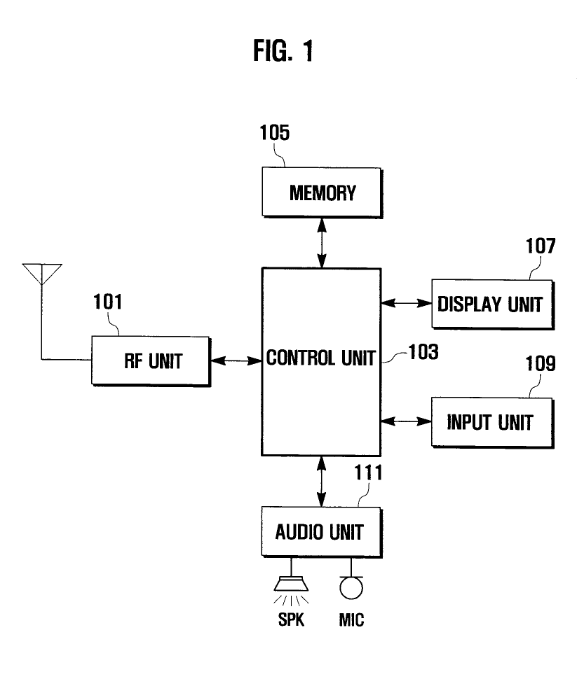

FIG. 1 is a block diagram showing major components of a portable terminal adapted to automatically notify of a schedule according to an embodiment of the present invention.

Referring to FIG. 1, the portable terminal includes an RF unit 101, a control unit 103, a memory 105, a display unit 107, an input unit 109, and an audio unit 111.

The RF unit 101 conducts conventional wireless communication between the portable terminal and a mobile communication network. For example, the RF unit 101 transmits/receives voice data, text messages, or multimedia messages via the mobile communication network.

The control unit 103 controls the overall operation occurring in the internal block of the portable terminal. Particularly, the control unit 103 includes a modem and a codec. The modem has a transmitter for encoding and modulating signals, which are transmitted by the RF unit 101, and a receiver for demodulating and decoding received signals.

The control unit 103 detects a schedule notification event stored in the memory 105 and determines whether the schedule notification event is a normal schedule notification event or an integrated schedule notification event. In the case of a normal schedule notification event, the control unit 103 controls the display unit 107 so as to display the normal schedule; and, in the case of the integrated schedule notification event, the control unit 103 determines if an integrated schedule corresponding to the predetermined period of time exists. Depending on the result of determination, the display unit 107 is controlled either to display the integrated schedule or to display a message informing that no integrated schedule exists.

In addition, the control unit 103 controls a series of operations for transmitting a text message containing the schedule displayed by the display unit 107.

The memory 105 stores information regarding the operation of the portable terminal (e.g. information regarding settings, menus) under the control of the control unit 103.

Under the control of the control unit 103, the memory 105 stores information regarding the desired notification date and time and particulars of normal schedules, which have been inputted by the input unit 109, as well as the desired notification date and time of integrated schedules.

The display unit 107 displays the condition and result of a series of operations occurring in the internal block of the portable terminal together with various pieces of information under the control of the control unit 103. The display unit 107 may consist of an LCD (Liquid Crystal Display), an OLED (Organic Light Emitting Diode), or a PDP (Plasma Display Panel).

The input unit 109 consists of a conventional keypad. Alternatively, the input unit 109 may include a touch screen, a touch pad, and a scroll wheel. The input unit 109 receives operation signals for controlling the operation of the portable terminal and provides the control unit 103 with the signals.

The audio unit 111 converts analog audio signals, which are inputted via a microphone, into digital signals. In addition, the audio unit 111 converts digital audio signals, which are outputted by the control unit 103, into analog audio signals and plays the audio signals via a speaker.

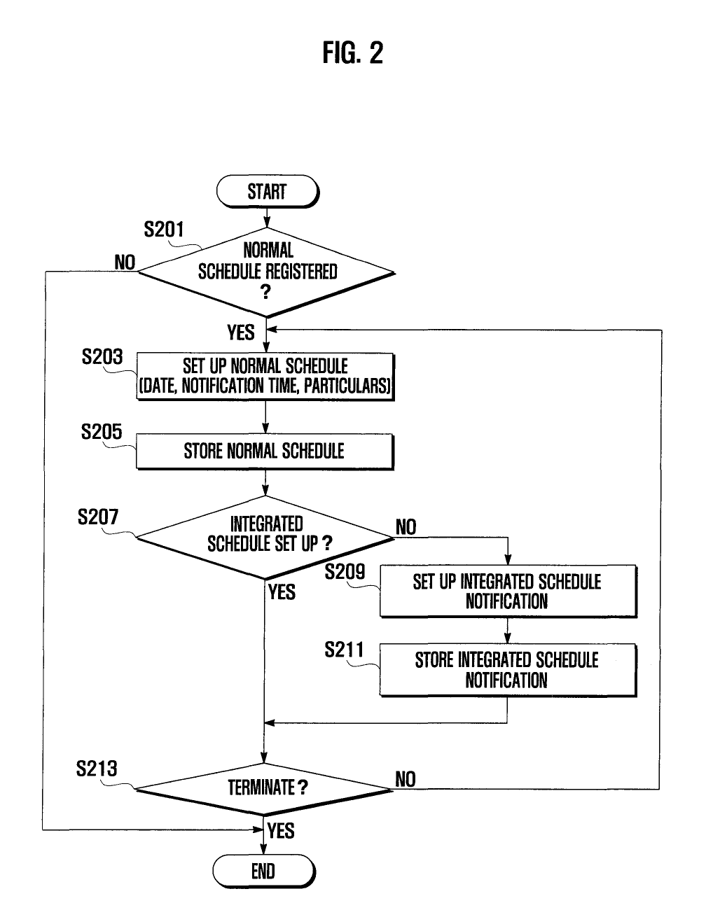

FIG. 2 is a flowchart showing a method for determining particulars necessary to automatically notify of a schedule according to an embodiment of the present invention.

Referring to FIG. 2, the control unit 103 determines in step S201 if a normal schedule is registered by the input unit 109. If so, the control unit 103 receives an input of the desired notification date and time and particulars of the normal schedule from the input unit 109 in step S203. The control unit 103 stores the normal schedule, which has been inputted in step S203, in the memory 105 in step S205.

The control unit 103 determines in step S207 if notification of an integrated schedule, which contains the notification date of the normal schedule, is selected. If not, the control unit 103 proceeds to step S209. Otherwise, the program logic proceeds to step S213.

The control unit 103 sets up the predetermined period of time and notification time of the integrated schedule based on the input from the input unit 109. For example, the period may be a week or a month according to the user's selection. The control unit 103 extracts normal schedules solely corresponding to the predetermined period of time from the memory 105 at the beginning of the predetermined period of time and at the notification time.

The control unit 103 stores the predetermined period of time and notification time regarding the integrated schedule in the memory 105 based on input signals from the input unit 109 in step S211, and proceeds to step S213.

The control unit 103 determines in step S213 whether a termination command is inputted from the input unit 109. Based on the result of determination, the control unit 103 repeats step S203 and adds a normal schedule. Alternatively, the control unit 103 terminates the setup procedure for automatic schedule notification. It is to be noted that the step for registering a normal schedule and that for registering an integrated schedule do not necessarily follow the order shown in FIG. 2, and may be modified as desired.

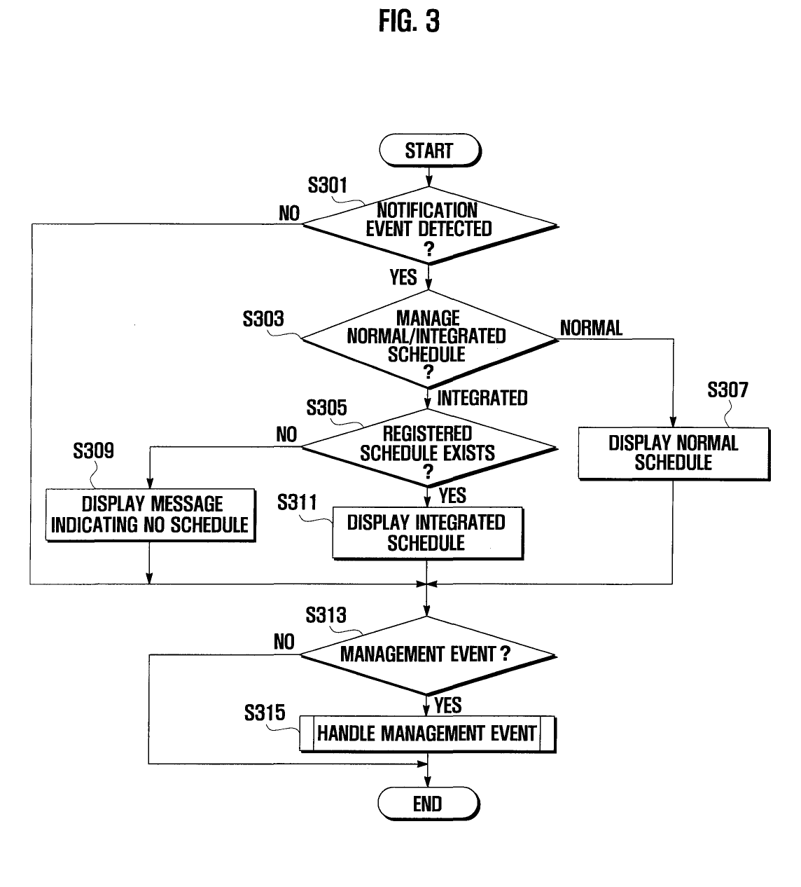

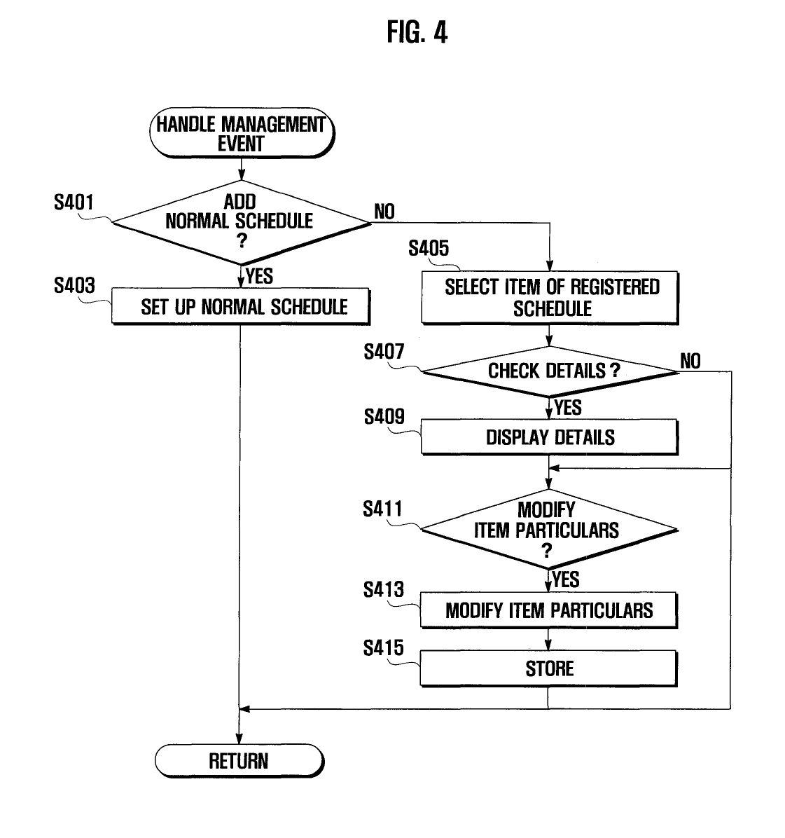

FIG. 3 is a flowchart showing a method for displaying a schedule according to an embodiment of the present invention, and FIG. 4 is a flowchart showing a detailed method for managing a schedule according to an embodiment of the present invention. Those skilled in the art can easily understand that, although its has been assumed for convenience of description that any schedule is managed by using the integrated schedule screen, which is provided according to whether a notification event is detected, the present invention is not limited to this assumption. For example, schedules can be managed after accessing the schedule menu of the portable terminal.

Referring to FIGS. 3 and 4, the control unit 103 refers to the current point of time of the portable terminal (e.g. current date and time counted by the portable terminal) and determines if a predetermined schedule notification event corresponding to the current point of time is detected in step S301. Based on the result of determination, the control unit 103 proceeds to step S303 and determines if the schedule notification event detected in step S301 is whether a normal schedule notification event or an integrated schedule notification event. In the case of an integrated schedule notification event, the control unit proceeds to step S305 and, in the case of a normal schedule notification event, proceeds to step S307. The control unit 103 controls the display unit 107 so as to display the notification date and time and particulars of the normal schedule in step S307.

The schedule notification event is determined to be a normal schedule notification event if the point of time of the portable terminal corresponds to the notification date and time, which have been determined with regard to the normal schedule. The schedule notification event is determined to be an integrated schedule notification event if the point of time of the portable terminal is the same as the beginning of the predetermined period of time regarding the integrated schedule and the predetermined notification time.

The control unit 103 determines if a normal schedule corresponding to the predetermined period of time is stored in the memory 105 in step 305. If the memory 105 has no normal schedule to be displayed as an integrated schedule, the control unit 103 proceeds to step S309 and controls the display unit 107 so as to display message information that there is no schedule stored. If a normal schedule is stored in the memory 105, the control unit 103 controls the display unit 107 to display all normal schedules, which correspond to the predetermined period of time, as a schedule list in step S311.

The control unit 103 determines if a management event regarding the displayed schedule list has occurred in step S313 and, if so, proceeds to step S315. The step S315 for handling the management event will now be described in detail.

The control unit 103 receives an input regarding whether to add a normal schedule from the input unit 109 in step S401 and proceeds to step S403 or S405. In response to the input result, the control unit 103 receives an input of the notification date and time and particulars of the normal schedule from the input unit 109 in step S403.

The control unit 103 receives selection of a schedule from the integrated schedule list, which has been displayed in step S311 shown in FIG. 3, from the input unit 109 in step S405.

The control unit 103 determines if the details of the selected schedule are to be checked in step S407. Based on the result of determination, the control unit 103 proceeds to step S409 and controls the display unit 107 so as to display the details of the selected schedule.

If it is determined in step S407 that the details of the selected schedule are not to be checked, the control unit 103 proceeds to step S411 and determines if the selected schedule is to be modified. Based on the result of determination in step S411, the control unit 103 proceeds to step S413 and modifies the schedule according to input signals from the input unit 109. The control unit 103 stores the modification particulars in the memory 105 in step S415.

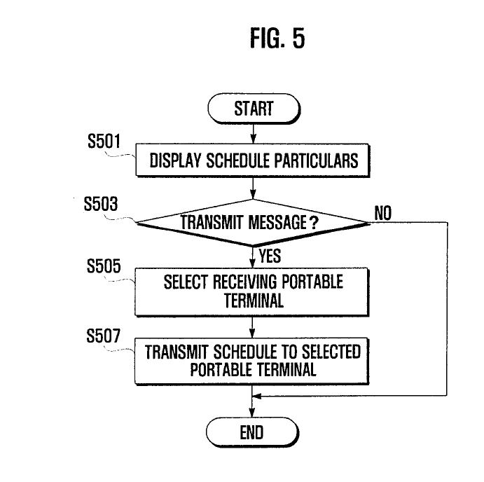

FIG. 5 is a flowchart showing a method for transmitting a text message so as to notify of a schedule according to an embodiment of the present invention.

Referring to FIG. 5, the display unit 107 displays a normal schedule or an integrated schedule under the control of the control unit 103 in step S501. The control unit 103 receives an input regarding whether or not to transmit a text message containing the normal or integrated schedule, which has been displayed by the display unit 107, in step S503. Based on the input received in step S503, the control unit 103 receives an input of the telephone number of the receiving-side portable terminal, to which the schedule is to be transmitted, in step S505. The control unit 103 transmits the schedule to the portable terminal, which has the inputted telephone number, in step S507.

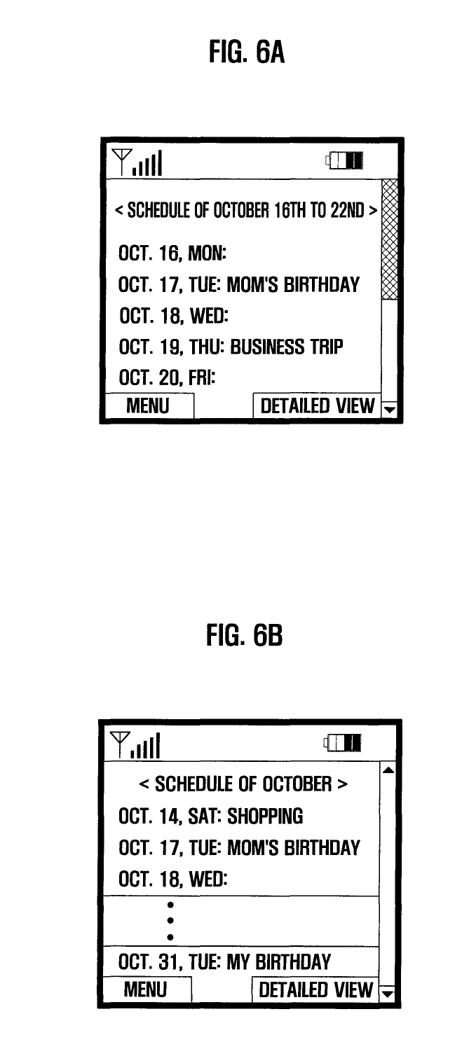

FIG. 6A shows an exemplary screen displaying an integrated schedule for a week according to an embodiment of the present invention, and FIG. 6B shows an exemplary screen displaying an integrated schedule for a month according to an embodiment of the present invention.

Referring to FIG. 6A, when a schedule notification event is detected on Oct. 16, 2006, all normal schedules corresponding to a week from October 16^{th} to Oct. 22^{nd}, 2006, are displayed as an integrated schedule at the beginning of a predetermined time, i.e. on Monday, October 16^{th}. The corresponding screen appears on the display unit 107 at the notification time, which has been determined by the user in step S207 shown in FIG. 2, on Oct. 16, 2006.

Normal schedules inputted in step S203 shown in FIG. 2 are displayed in the following manner: Tuesday, October 17^{th}: Mom's birthday; Thursday, October 19^{th}: Business trip; etc. By selecting one of the normal schedules, the user can check the particulars of the selected schedule (i.e. notification date, notification time, schedule particulars) or modify the particulars thereof. When the notification date and time of each normal schedule arrives, its particulars are displayed again.

The week from October 16^{th} to October 22^{nd} corresponds to the period of time determined in step S207. The user is notified of the integrated schedule by displaying the integrated schedule list on the display unit and generating a predetermined type of bell sound or vibration.

Referring to FIG. 6B, when a schedule notification event is detected on Oct. 1, 2006, all normal schedules corresponding to a month from October 1^{st} to October 31^{st} are displayed as an integrated schedule at the beginning of a predetermined time, i.e. on October 1^{st}. The corresponding screen appears on the display unit 107 at the notification time, which has been determined by the user in step S207 shown in FIG. 2, on Oct. 1, 2006.

Normal schedules inputted in step S203 shown in FIG. 2 are displayed in the following manner: Saturday, October 14^{th}: Shopping; Tuesday, October 17^{th}: Mom's birthday; Thursday, October 19^{th}: Business trip; Tuesday, October 31^{st}: My birthday; etc. By selecting one of the normal schedules, the user can check the particulars of the selected schedule (i.e. notification date, notification time, schedule particulars) or modify the particulars thereof. When the notification date and time of each normal schedule arrives, its particulars are displayed again.

The month from October 1^{st} to 31^{st} corresponds to the period of time determined in step S207. The user is notified of the integrated schedule by displaying the integrated schedule list on the display unit and generating a predetermined type of bell sound or vibration.

The period of time, notification date, and notification time shown in FIGS. 6A and 6B may be determined by the user as desired. Days having no registered schedules may also appear on the screen, which shows the integrated schedule, as in the case of FIG. 6A. Alternatively, days having registered schedules may solely appear on the screen as in the case of FIG. 6B.

As apparent from the above description, the present invention is advantageous in that, by showing all schedules corresponding to a predetermined period of time at the notification time, the user can manage his/her schedule more efficiently.

In addition, when the user wants to modify the particulars of a schedule belonging to a predetermined period of time, he/she can simply select the schedule on the notification screen without having to going through a number of menus.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While exemplary embodiments of the present invention have been shown

What is claimed is:

1. A method for automatically notifying of a schedule by a portable terminal, the method comprising the steps of:
detecting an integrated schedule notification event;
extracting registered normal schedules corresponding to a period of time selected for integrated schedules; and
displaying -the extracted normal schedules as the integrated schedule.

2. The method as claimed in claim 1, further comprising the steps of:
selecting a period of time for displaying the integrated schedule;
selecting a notification time for displaying the registered normal schedules corresponding to the period of time as the integrated schedule; and
storing the period of time and the notification time.

3. The method as claimed in claim 1, wherein, in the step of detecting the integrated schedule notification event, it is decided if date and time of the portable terminal are equal to a starting point of the period of time and the notification time.

4. A method for automatically notifying of a schedule by a portable terminal, the method comprising the steps of:
(a) selecting an integrated schedule notification event; and described in this specification, it will be understood by those skilled in the art that various changes or modifications of the embodiments are possible without departing from the spirit and scope of the invention as defined by the appended claims.
(b) detecting a schedule notification event of the portable terminal;
(c) determining if the detected schedule notification event corresponds to the selected integrated schedule notification event; and
(d) displaying an integrated schedule when the integrated schedule notification event is detected.

5. The method as claimed in claim 4, wherein step (a) comprises the steps of:
selecting a period of time for displaying the integrated schedule;
selecting a notification time for displaying registered normal schedules corresponding to the period of time as the integrated schedule; and
storing the period of time and the notification time.

6. The method as claimed in claim 4, wherein, in step (c), it is decided whether the detected schedule notification event is a normal schedule notification event or the integrated schedule notification event.

7. The method as claimed in claim 6, wherein the detected schedule notification event is determined to be the normal schedule notification event when date and time of the portable terminal are identical to a notification date and a notification time determined with regard to normal schedules.

8. The method as claimed in claim 4, wherein, in step (d), registered normal schedules corresponding to a predetermined period of time are displayed as the integrated schedule at a notification time determined with regard to the integrated schedule notification event.

9. The method as claimed in claim 4, further comprising the step of: determining if the registered normal schedule corresponding to a period of time exists.

10. The method as claimed in claim 9, further comprising the step of: displaying a message notifying that there is not the integrated schedule to be displaying during the period of time when the normal schedule does not exist.

11. The method as claimed in claim 4, further comprising the step of: transmitting the displayed schedule to at least one portable terminal as a text message.

12. A method for automatically notifying of a schedule by a portable terminal, the method comprising the steps of:
selecting an integrated schedule notification event;
detecting a schedule notification event of the portable terminal;
determining if the detected schedule notification event corresponds to the selected integrated schedule notification event; and
displaying all registered normal schedules corresponding to a period of time as an integrated schedule when the integrated schedule notification event is detected.

13. The method as claimed in claim 12, wherein the detected schedule notification event is determined to be a normal schedule notification event when date and time displayed by the portable terminal are identical to a notification date and a notification time determined with regard to the normal schedules.

14. The method as claimed in claim 12, wherein the detected schedule notification event is determined to be the integrated schedule notification event when date and time of the portable terminal are identical to a starting point of the period of time and a notification time determined with regard to the integrated schedule.

15. The method as claimed in claim 14, further comprising the step of: determining if the registered normal schedule corresponding to the period of time exists when the schedule notification event is the integrated schedule notification event.

16. The method as claimed in claim 15, further comprising the step of: displaying a message notifying that there is no integrated schedule to be displayed for the period of time when no normal schedule exists.
